(19) United States
(12) Patent Application Publication
(10) Pub. No.: US 2021/0056688 A1
(43) Pub. Date: Feb. 25, 2021

(54) USING DEEP LEARNING TO REDUCE METAL ARTIFACTS

(71) Applicant: KONINKLIJKE PHILIPS N.V., EINDHOVEN (NL)

(72) Inventors: SHIYU XU, MAYFIELED HEIGHTS, OH (US); HAO DANG, MAYFIELED HEIGHTS, OH (US)

(21) Appl. No.: 16/964,675

(22) PCT Filed: Jan. 9, 2019
(86) PCT No.: PCT/EP2019/050469

§ 371 Date: Jul. 24, 2020

Related U.S. Application Data
(60) Provisional application No. 62/622,170, filed on Jan. 26, 2018.

(51) Int. Cl. G06T 7/00; G06T 7/11; G06T 5/50; G06K 9/32

(52) U.S. Cl. CPC G06T 7/0012; G06T 7/11; G06T 5/50; G06T 2207/20084; G06T 2207/10104; G06T 2207/10081; G06T 2207/20081; G06K 9/3241

(57) ABSTRACT

An X-ray imaging device (10, 100) is configured to acquire an uncorrected X-ray image (30). An image reconstruction device comprises an electronic processor (22) and a non-transitory storage medium (24) storing instructions readable and executable by the electronic processor to perform an image correction method (26) including: applying a neural network (32) to the uncorrected X-ray image to generate a metal artifact image (34) wherein the neural network is trained to extract residual image content comprising a metal artifact; and generating a corrected X-ray image (40) by subtracting the metal artifact image from the uncorrected X-ray image.

### FIELD

The following relates generally to X-ray imaging, X-ray imaging data reconstruction, computed tomography (CT) imaging, C-arm imaging or other tomographic X-ray imaging techniques, digital radiography (DR), and to medical X-ray imaging, image guided therapy (iGT) employing X-ray imaging, positron emission tomography (PET)/CT imaging, and to like applications.

### BACKGROUND

Metal objects are present in the CT or other X-ray scan field-of-view (FOV) in many clinical scenarios, for example, the presence of pedicle screws and rods after spine surgery, metal ball and socket after total hip replacement, and screws and plates/meshes after head surgery, implanted cardiac pacemakers present during cardiac scanning via a C-arm or the like, interventional instruments used in iGT such as catheters that contain metal, and so forth. Severe artifacts can be introduced by metal objects, which often appear as streaks, “blooming”, and/or shading in the reconstructed volume. Such artifacts can lead to significant CT value shift and a loss of tissue visibility especially in regions adjacent to metal objects, which is often the region-of-interest in medical X-ray imaging. The causes of metal artifacts include beam hardening, partial volume effects, photon starvation, and scattered radiation in the data acquisition.

Metal artifact reduction methods generally replace projection data impacted by metal artifacts with synthesized projections based on surrounding projection samples via interpolation. In some techniques, additional corrections are applied in a second pass. Such approaches generally require segmentation of metal component and replacement of metal projections with synthesized projections, which can introduce error and miss details that were obscured by the metal. Moreover, techniques that operate to suppress metal artifacts can also operate to remove useful information about metal objects. For example, during installation of a metallic prosthesis, X-ray imaging may be used to visualize the location and orientation of the prosthesis, and it is not desired to suppress this information about the prosthesis in order to improve the anatomical image quality.

The following discloses certain improvements.

### SUMMARY

In some embodiments disclosed herein, a non-transitory storage medium stores instructions readable and executable by an electronic processor to perform an image reconstruction method including: reconstructing X-ray projection data to generate an uncorrected X-ray image; applying a neural network to the uncorrected X ray image to generate a metal artifact image; and generating a corrected X-ray image by subtracting the metal artifact image from the uncorrected X-ray image. The neural network is trained to extract image content comprising a metal artifact.

In some embodiments disclosed herein, an imaging device is disclosed. An X-ray imaging device is configured to acquire an uncorrected X-ray image. An image reconstruction device comprises an electronic processor and a non-transitory storage medium storing instructions readable and executable by the electronic processor to perform an image correction method including: applying a neural network to the uncorrected X-ray image to generate a metal artifact image wherein the neural network is trained to extract residual image content comprising a metal artifact; and generating a corrected X-ray image by subtracting the metal artifact image from the uncorrected X-ray image.

In some embodiments disclosed herein, an imaging method is disclosed. An uncorrected X-ray image is acquired using an X-ray imaging device. A trained neural network is applied to the uncorrected X-ray image to generate a metal artifact image. A corrected X-ray image is generated by subtracting the metal artifact image from the uncorrected X-ray image. The training, the applying, and the generating are suitably performed by an electronic processor. In some embodiments, the neural network is trained to transform polyenergetic training X-ray images pⱼ to match respective metal artifact images aⱼ where j indexes the training X-ray images and where pⱼ=mⱼ+aⱼ where image component mⱼ is a monoenergetic X-ray image.

One advantage resides in providing computationally efficient metal artifact suppression in X-ray imaging.

Another advantage resides in providing metal artifact suppression in X-ray imaging that effectively utilizes information contained in the two- or three-dimensional x-ray tomographic image in performing the metal artifact suppression.

Another advantage resides in providing metal artifact suppression in X-ray imaging without the need for a priori segmentation of the metal object(s) producing the metal artifact.

Another advantage resides in providing metal artifact suppression in X-ray imaging that operates on the entire image so as to holistically account for metal artifacts which can span a large portion of the image, or may even span the entire image.

Another advantage resides in providing metal artifact suppression in X-ray imaging while retaining information about the suppressed metal artifact sufficient to provide information on the metal object producing the metal artifact, such as its location, spatial extent, composition, and/or so forth.

Another advantage resides in providing metal artifact suppression in X-ray imaging that simultaneously segments the metal object and produces a corresponding metal artifact image.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 diagrammatically illustrates an X-ray imaging device including metal artifact suppression as disclosed herein, illustratively shown in the context of an illustrative C-arm imager of an image guided therapy (iGT) system.

FIG. 2 diagrammatically shows two illustrative phantoms used in testing.

FIGS. 3, 4, and 5 present images generated during testing described herein on the phantoms of FIG. 2.

FIG. 6 illustrates a method suitably performed by the X-ray imaging device of FIG. 1.

FIG. 7 illustrates configuration of a neural network to provide a receptive area that spans the area of the X-ray image.

### DETAILED DESCRIPTION

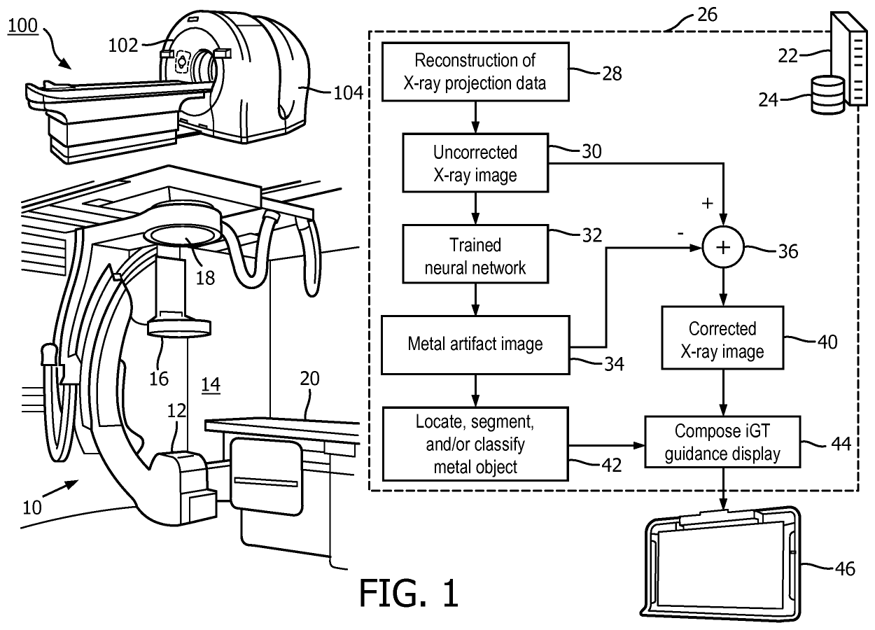

With reference to FIG. 1, an illustrative X-ray imaging device 10 for use in image-guided therapy (iGT) has a C-arm configuration and includes an X-ray source (e.g. X-ray tube) 12 arranged to project an X-ray beam through an examination area 14 to be detected by an X-ray detector array 16. In operation, an overhead gantry or other robotic manipulator system 18 arranges the X-ray hardware 12, 16 to place a subject (not shown, e.g. a medical patient) disposed on an examination table 20 in the examination area 14 for imaging. During the X-ray imaging data acquisition, the X-ray source 12 is operated to project an X-ray beam through the subject such that the X-ray intensities detected by the X-ray detector array 16 reflect absorption of X-rays by the subject. The robotic manipulator 18 may rotate the C-arm or otherwise manipulate positions of the X-ray hardware 12, 16 to obtain tomographic X-ray projection data. A computer or other electronic data processing device 22 reads and executes instructions (e.g. computer software or firmware) stored on a non-transitory storage medium 24 in order to perform an image reconstruction method 26 including image correction as disclosed herein. This method 26 includes performing reconstruction 28 of the X-ray projection data to generate an uncorrected X-ray image 30. This uncorrected X-ray image 30 is input to a neural network 32 which, as disclosed herein, is trained to extract image content comprising a metal artifact. Thus, applying the neural network 32 to the uncorrected X-ray image 30 operates to generate a metal artifact image 34, which contains the metal artifact content of the uncorrected X-ray image 30. In an image subtraction operation 36, the metal artifact image 34 is subtracted from the uncorrected X-ray image 30 to generate a corrected X-ray image 40 with suppressed metal artifact(s).

In an illustrative application, the X-ray imaging device 10 is used for image guided therapy (iGT). In this illustrative application, the corrected X-ray image 30 is a useful output, as it provides a more accurate rendition of the anatomy undergoing therapy under the image guidance. Moreover, it will be appreciated that in the iGT context the metal artifact image 34 may also be useful; this is diagrammatically represented in the method 26 of FIG. 1 by the operation 42 which may, for example, include locating, segmenting, and/or classifying the represented metal object. For example, the metal object that gives rise to the metal artifact captured in the metal artifact image 34 may be a metal prosthesis (e.g. a metal replacement hip or knee prosthesis) whose position and orientation is to be visualized by the image guidance provided by the X-ray imaging device 10. In the case of prosthesis implantation iGT, the detailed shape of the prosthesis is often known, in which case the metal artifact image 34 can be processed to segment the metal object (e.g. prosthesis) and then the a priori known precise shape of the prosthesis may be substituted to improve sharpness of the edges of the segmented metal object (e.g. prosthesis) in the metal artifact image. Advantageously, the metal object is more easily segmented in the metal artifact image 34 because the metal artifact image 34 principally represents the metal artifact in isolation from the remainder of the uncorrected X-ray image 30. Additionally, since the metal artifact image 34 is derived from the uncorrected X-ray image 30 by operation of the neural network 32, it is inherently spatially registered with the uncorrected X-ray image 30. The metal artifact may also be located or segmented in the corrected X-ray image 40. In a hybrid approach, the metal artifact image 34 is used to determine an initial, approximate boundary of the metal artifact which is then refined by adjusting this initial boundary using the corrected X-ray image 40 which may exhibit sharper boundaries for the metal artifact. In yet another application, the metal artifact image 34 may be displayed on the display 46 so as to show how the metal artifact(s) are distributed in the image and to allow the user to visually confirm that there is no diagnostic information in artifact mapping captured by the metal artifact image 34.

In another example, if the metal object is a previously installed implant of unknown detailed construction, then by considering the density of the metal artifact image 34 it may be possible to classify the metal object as to metal type, as well as estimate object shape, size, and orientation in the patient's body.

In an operation 44, for the illustrative iGT application the corrected X-ray image 40 may be fused or otherwise combined with the metal artifact image 34 (or an image derived from the metal artifact image 34) to generate an iGT guidance display that is suitably shown on a display 46 for consultation by the surgeon or other medical personnel.

It is to be appreciated that FIG. 1 diagrammatically illustrates one exemplary embodiment in which a C-arm imager 10 is employed in iGT. More generally, the X-ray imaging device may be the illustrative C-arm imager, or may be alternatively be an illustrated positron emission tomography/computed tomography (PET/CT) imaging device 100 having a CT gantry 102 and a PET gantry 104, in which the CT gantry 102 acquires a CT image that is corrected for metal artifacts as disclosed herein before being used for generating an attenuation map for the PET imaging via PET gantry 104, or may be another tomographic x-ray imaging device (further examples not shown) such as a digital radiography (DR) device, or any other X-ray imaging device that outputs the uncorrected X-ray image 30. While iGT is shown as an illustrative application, the corrected X-ray image 40 may have numerous other applications. For example, in the context of a “hybrid” PET/CT imaging device, the corrected X-ray image 40 may be used to generate an attenuation map for use during PET imaging. Compared to a CT image with residual metal artifacts, a corrected CT image may yield a more accurate attenuation map for use in the PET image reconstruction, which in turn may yield a PET image with higher image quality. For general clinical diagnosis, the corrected X-ray image 40 in the form of a corrected digital radiograph, corrected CT image, corrected cardiac image obtained using a C-arm X-ray imager or the like, or so forth is advantageously used for diagnostic or clinical interpretation due to the suppression of metal artifacts.

The metal artifact image 34 produced by applying the trained neural network 32 to the uncorrected X-ray image 30 is a residual image, that is, an image of the metal artifact. Thus, the residual image 34 is subtracted from the uncorrected X-ray image 30 to generate the corrected X-ray image 40. This residual image approach has certain advantages, including providing improved training for the neural network 32 and providing the metal artifact (i.e. residual) image 34 which can be useful in and of itself or in combination with the corrected X-ray image 40.

In the following, some illustrative examples are described.

In an illustrative example, the neural network 32 is a modified VGG network of the convolutional neural network (CNN) type (see, e.g. Simonyan et al., “Very deep convolutional networks for large-scale image recognition,” arXiv Prepr. arXiv1409.1556 (1409) (ICLR 2015). The depth of the network is set according to the desired receptive field, e.g. the neural network 32 has a number of layers and a kernel size effective to provide global connectivity across the uncorrected X-ray image 30. The residual learning formulation is employed.

In illustrative examples reported herein, each input data in training set is a two-dimensional (2D) image with 128 pixel by 128 pixel. The size of the convolution filter is set to 3×3 but remove all pooling layers. Metal artifacts typically appear as dark or blooming texture extended over a long distance from the metal object. Therefore, a large receptive field is expected to be beneficial. A dilate factor of 4 was utilized, and the depth of convolutional layer was chosen to be d=22 to create a receptive field of 126 by 126, which almost covers the entire image so as to provide global connectivity across the uncorrected X-ray image 30.

The first convolution layer in the illustrative CNN consists of 64 filters of size 3×3, layers 2-21 each consist of 64 filters of size 3×3×64 with the dilate factor of 4, and the last layer consists of a single filter of size 3×3×64. Except for the first and last layers, each convolution layer is followed by a batch normalization, which is included to speed up training as well as boost performance, and rectified linear units (ReLU), which are used to introduce nonlinearity. Zero padding is performed in each convolution layer to maintain the correct data dimensions.

For training purposes, each input training image p to the CNN(p) is a 2D image from polychromatic (or, equivalently, poly-energetic) simulation and reconstruction. The training image p may be decomposed as p=m+a, where m is considered to be a metal artifact-free X-ray image, such as an image reconstructed from a monochromatic simulation, and a is the metal artifact image component. The residual learning formulation is applied to train a residual mapping T(p)˜a, from which the desired signal m is determined as m=p−T(p). The CNN parameters are estimated by minimizing the following loss function:

$$L ( w ) = {\sum }_{j} ( {‖ Mask ( {T ( p ; w )}_{j} - {a}_{j} ) ‖}_{2}^{2} + {λ}_{1} {‖ Mask ( ∇ {T ( p ; w )}_{j} ) ‖}_{1} ) + {λ}_{2} {\sum }_{k} {‖ {w}_{k} ‖}_{2}^{2} \qquad ( 1 )$$

where Mask is a function that selects the image except for the metal region. Using such a mask is expected to lead to faster convergence in training since the cost function is expected to focus more on regions with visible metal artifacts. The parameter w is the set of all convolutional kernels of all layers and k=1, . . . , 22 denotes the layer index. The regularization terms encourage smoothed metal artifacts and small network kernels. Examples reported herein used the regularization parameters Δ₁=10⁻⁴, Δ₂=10⁻³. Here {(pⱼ, aⱼ)}ⱼ₌₁^{N} represents N training pairs of input image and label image, where j is the index of training unit. The regularization term λ₁∥Mask(∇T(p; w)ⱼ)∥₁ provides smoothing, while the regularization term λ₂Σₖ∥wₖ∥₂² penalizes larger network kernels.

The minimization of the loss function L(w) was performed using conventional error backpropagation with stochastic gradient descent (SGD). In the SGD, an initial learning rate was set to 10⁻³, and the learning rate was continuously decreased to 10⁻⁵. Mini-batches of size 10 were used, meaning that 10 randomly chosen sets of data were used as a batch for training. The method was implemented in MATLAB (MathWorks, Natick Mass.) using MatConvNet (see, e.g. Vedaldi et al., “MatConvNet—Convolutional Neural Networks for MATLAB,” Arxiv (2014)).

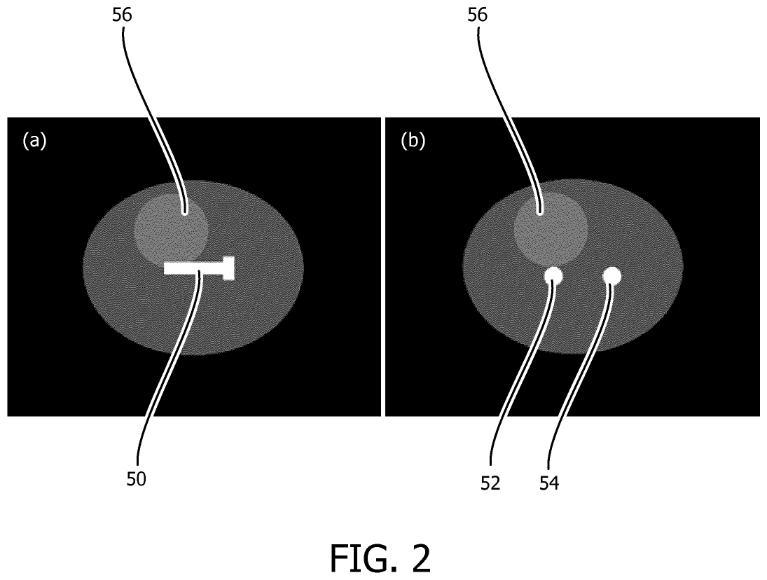

With reference now to FIG. 2, to generate training sets, mono- and poly-chromatic projections (or, equivalently, mono- and poly-energetic projections) of digital phantoms containing metal objects were simulated. As shown in FIG. 2, CNN training sets were generated from a digital phantom that contained either a surgical screw 50 within the transaxial plane (a: left-hand image of FIG. 2) or two metal rod implants 52, 54 along the craniocaudal direction (b: right-hand image of FIG. 2). The grayscale window was [−400, 400] HU. For evaluation, a physical phantom (not shown) containing a titanium rod and a stainless steel rod in a Nylon phantom body was scanned on a CT scanner to evaluate the performance of the trained neural network. The simulation parameters were chosen to mimic the characteristics of a Philips Brilliance iCT scanner (Philips Healthcare, Highland Heights Ohio), which has 672 detectors per slice and acquires 1200 projections over one gantry rotation. The simulation was performed in axial scan mode at a tube voltage of 120 kVp. Two scenarios were considered: (i) the presence of the surgical screw 50 within the transaxial plane (left-hand image of FIG. 2); and (ii) the presence of two metal rod implants 52, 54 along the craniocaudal direction (right-hand image of FIG. 2). The digital phantom also contains a water ellipse 56 (major axis ˜150 mm, minor axis ˜120 mm) to simulate body attenuation. A circular insert (diameter ˜50 mm, attenuation 100 HU higher than water) was also added to examine the performance of the proposed method in the presence of relatively low contrast object. The metal material was assumed to be Titanium in the simulations. The monochromatic projections were simulated assuming an effective energy of 71 kV of the incident x-ray spectrum. The poly-chromatic projections were simulated according to:

I=∫_{E}I₀(E)exp(−∫ₜμ(E)dl)dE (2)

where I₀(E) denotes the incident x-ray spectrum as a function of photon energy E, I is total transmitted intensity, and l is path length computed using a custom Graphical Processor Unit (GPU)-based forward projector. The simulated mono- and poly-chromatic projections were then reconstructed using three-dimensional (3D) filtered-backprojection (FBP) to form “Mono” (regarded as ground truth) and “Poly” images (containing metal artifacts) respectively. The “Poly” images were used as input signal s and the difference image between “Mono” and “Poly” were used as residual signal r in CNN training. The reconstructed image has 512×512 pixels in each slice and a FOV of 250 mm.

The training sets were composed of “screw” and “rods”. “Screw” sets were generated by translating the screw 50 in each of x and y directions from −80 mm to 80 mm and rotating the screw 50 about z axis covering ˜180 degree, together forming 1024 cases of object variability. “Rods” sets were generated by translating the two rods 52, 54 in each of x and y directions from −60 mm to 60 mm, rotating about z axis covering ˜180 degree, and varying the distance between two rods 52, 54 from 40 mm to 150 mm, together forming 1280 cases of object variability. A total number of 1024+1280=2304 sets were used to train the proposed network. Due to the intensive computation in training, each reconstructed image was downsampled to 128×128 pixels. The total training time was ˜4 hours on a workstation (Precision T7600, Dell, Round Rock Tex.) with a GPU (GeForce TITAN X, Nvidia, Santa Clara Calif.).

The trained network was tested on both simulated and experimentally measured data. Testing projections were simulated when the screw 50 or rods 52, 54 were translated, rotated, and separated (only for the rod scenario) in a way that was not included in the training set. The “Poly” images reconstructed from the testing projections were used as CNN input, and the “Mono” images were used as ground truth to compare to CNN output. In addition, a custom phantom designed to mimic large orthopedic metal implants was scanned on a Philips Brilliance iCT scanner. The phantom contains a titanium rod and a stainless steel rod (two commonly used metals for orthopedic implants) in a 200 mm diameter Nylon phantom body. The scan was performed in axial model with a 10 mm collimation (narrow collimation chosen to minimize scatter effects), 120 kVp tube voltage, and 500 mAs tube current. An image containing metal artifacts with 128×128 pixels and 250 mm reconstruction FOV was obtained by intentionally disabling the scanner's metal artifact reduction algorithm and was used as the CNN input.

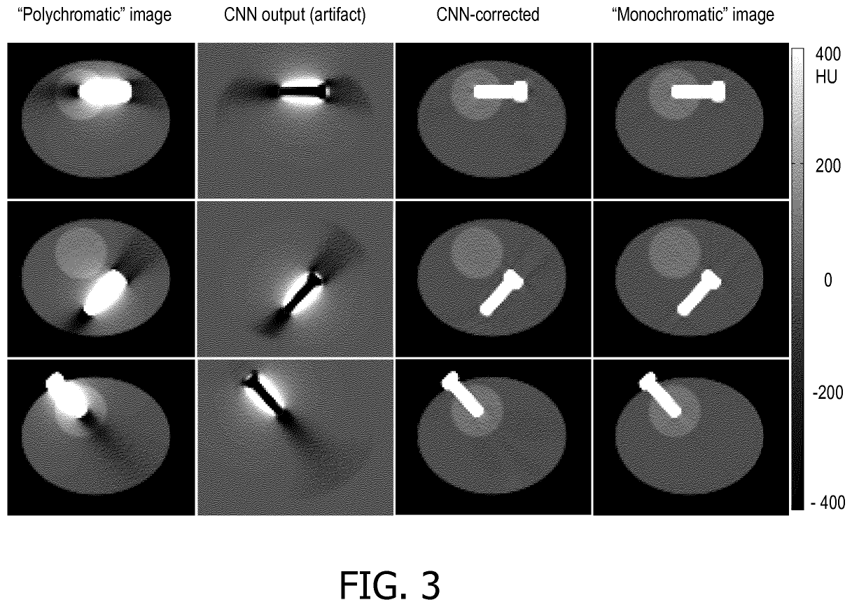

With reference to FIG. 3, results in the screw scenario are shown. Each row in FIG. 3 represents an example of a particular combination of translation and rotation of the screw 50. The “Polychromatic” image (reconstructed from projections simulated using polychromatic x-ray) showed severe shading and “blooming”. These artifacts were detected by the trained neural network as seen in the second column of FIG. 3, labeled “CNN Output (Artifact)”. The third column of FIG. 3 shows the “CNN Corrected” images, obtained by subtracting the “CNN Output” image from the “Polychromatic” image. As seen in the “CNN Corrected” images, the metal artifacts were almost completely removed in the CNN-corrected images, leading to recovered attenuation information including contour information of the insert. Some residual artifacts can be seen when compared to “Monochromatic” images (reconstructed from projections simulated using monochromatic x-ray, and serving as the “ground truth” images for the testing) and may be potentially reduced by increasing the size of training sets. The CNN correction speed was about 80 images per second.

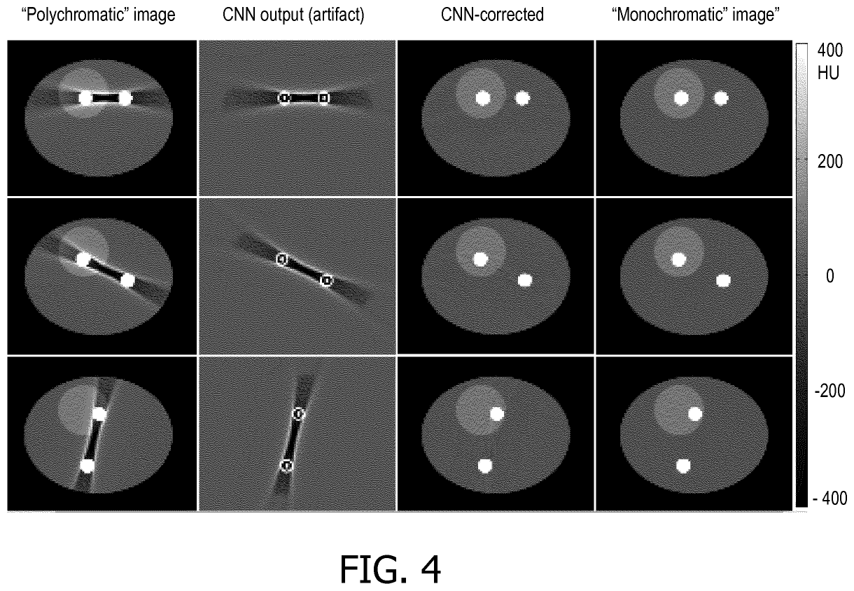

With reference to FIG. 4, results in the rod scenario are shown. Each row in FIG. 4 represents an example of a particular combination of translation, rotation, and separation between the two rods 52, 54. Similar to the screw scenario, metal artifacts such as shading and streaks seen in the “Polychromatic” images (leftmost column) were almost entirely removed in the “CNN-corrected” images generated by subtracting the “CNN Output (Artifact” images (second column from left) from the “Polychromatic” images. The rightmost column again shows the ground truth “Monochromatic” images for comparison.

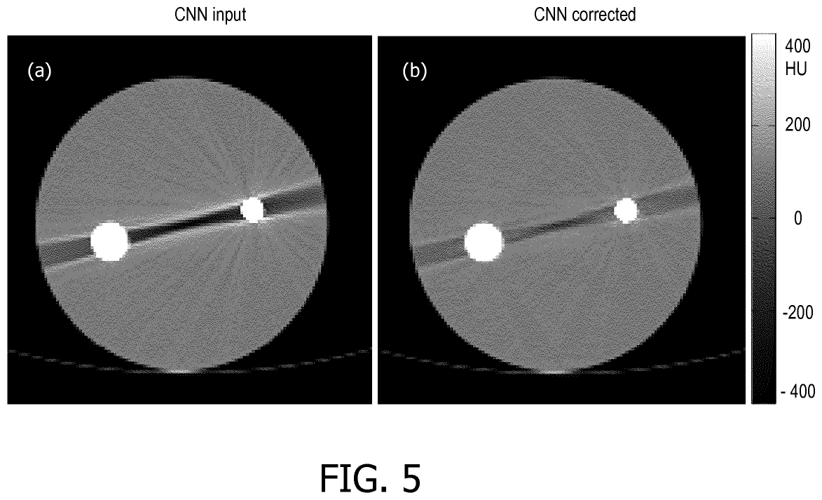

With reference to FIG. 5, results for imaging of the physical phantom are shown. The left-hand image (a) is the uncorrected CT image, while the right-hand image (b) is the CNN corrected image. The physical phantom used in the scan presents a number of differences in object variability from the digital rod phantom used in training, including the shape and material (Nylon versus water) of the phantom body and the size and material (stainless steel and titanium versus only titanium) of the metal rods. The image reconstructed using the measured data without metal artifact correction (left-hand image (a)) exhibits severe shading and streaks. These artifacts were largely reduced in the CNN-corrected image (right-hand image (b)), yielding a more uniform image in the phantom body. The residual artifacts may be caused by other physical effects such as metal material dependency, partial volume effects, and photon starvation.

The disclosed deep residual learning framework trains a deep convolutional neural network 32 to detect and correct for metal artifacts in CT images (or, more generally, X-ray images). The residual network trained by polychromatic simulation data demonstrates the capability to largely reduce or, in some cases, almost entirely remove metal artifacts caused by beam hardening effects.

It is to be understood that the results of FIGS. 3-5 presented herein, are merely illustrative, and that numerous variations are contemplated. For example, the loss function L(w) of Equation (1) may be replaced by any other loss function that effectively quantifies the difference between the neural network output T(p) and the ground truth artifact image a. In the illustrative training, the ability to simulate a monochromatic image as the ground truth was leveraged, as the monochromatic image is substantially unaffected by metal artifact mechanisms such as beam hardening or blooming. However, more generally other training data sources may be leveraged. For example, training images acquired of phantoms or human imaging subjects may be processed by computationally intensive metal artifact removal algorithms to produce training data for training the neural network 32 to effectively perform the artifact removal function of the computationally intensive metal artifact removal algorithm at greatly reduced computational cost, thus providing for more efficient image reconstruction with metal artifact removal. As noted above, in experiments the CNN correction speed was about 80 images per second, which is practical for use in correcting “live” images generated by a C-arm 10 (e.g. FIG. 1) during an iGT procedure. Furthermore, as seen in FIGS. 3 and 4, the metal artifact image (second column from left in FIGS. 3 and 4) can provide effectively segmented representation of the metal artifact. Although this image exhibits blooming or other distortion compared with the actual boundaries of the metal object causing the artifact, it is seen that the metal artifact image provides an isolation image of the metal object that can, for example, be fitted to a known metal object geometry to provide for accurate live tracking of a biopsy needle, metal prosthesis, or other known metal object that is to be manipulated during the iGT procedure. In one approach, the corrected X-ray image 40 is displayed on the display 46 with the metal artifact image 34 (or an image derived from the metal artifact image 34, such as an image of the underlying metal object positioned to be spatially registered with the metal artifact image 34) is also displayed on the display 46, e.g. superimposed onto or otherwise fused with the display of the corrected X-ray image 40. As another application, the density of the image of the metal object captured in the metal artifact image 34 (or other information such as the extent of blooming) may be used to classify the metal object as to metal type, or the metal object depicted by the metal artifact image 34 may be identified based on shape, and/or so forth. In some embodiments, an identification approach such as one disclosed in Walker et al., U.S. Pub. No. 2012/0046971 A1 (published Feb. 23, 2012) may be used. In some embodiments, to maximize processing speed for live imaging during iGT or other time-critical imaging tasks, the image reconstruction method 26 does not include any metal artifact correction other than by applying the neural network 32 to the uncorrected X-ray image 30 to generate the metal artifact image 34 and generating the corrected X-ray image 40 by subtracting the metal artifact image from the uncorrected x ray image.

In the illustrative examples (e.g. FIGS. 3-5), the processing was performed on 2D images. However, in other contemplated embodiments, the uncorrected X-ray image 30 is a three-dimensional (3D) uncorrected X-ray image, and the neural network 32 is applied to the three-dimensional uncorrected X-ray image to generate the metal artifact image 34 as a three-dimensional metal artifact image. This approach can be advantageous as the streaks, blooming, and other metal artifacts commonly extend three-dimensionally, and hence are most effectively corrected by processing the 3D uncorrected X-ray image 30 in 3D space (as opposed to breaking it into 2D slices and individually processing the 2D image slices).

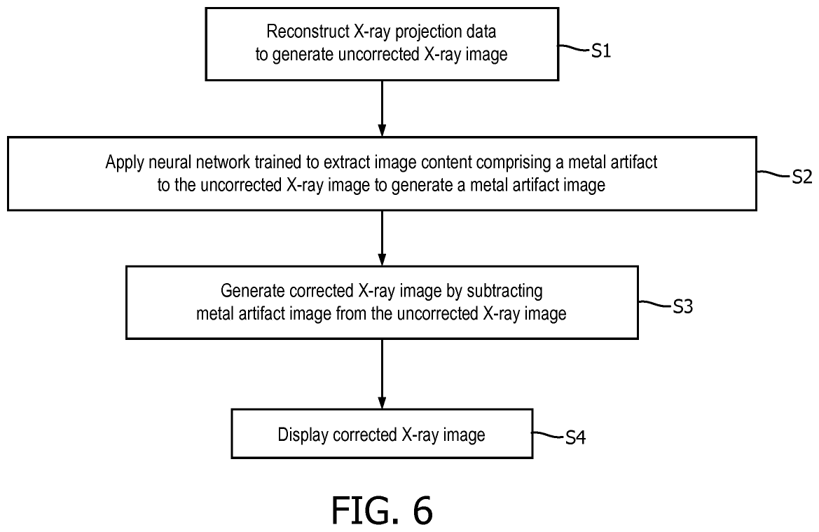

With reference to FIG. 6, an illustrative method suitably performed by the X-ray imaging device of FIG. 1 is shown by way of a flowchart. In an operation S1, X-ray projection data are reconstructed to generate the uncorrected X-ray image 30. In an operation S2, the neural network 32 trained to extract image content comprising a metal artifact is applied to the uncorrected X-ray image 30 to generate the metal artifact image 34. In an operation S3, the corrected X-ray image 40 is generated by subtracting the metal artifact image 34 from the uncorrected X-ray image 30. In an operation S4, the corrected X-ray image 40 is displayed on the display 46.

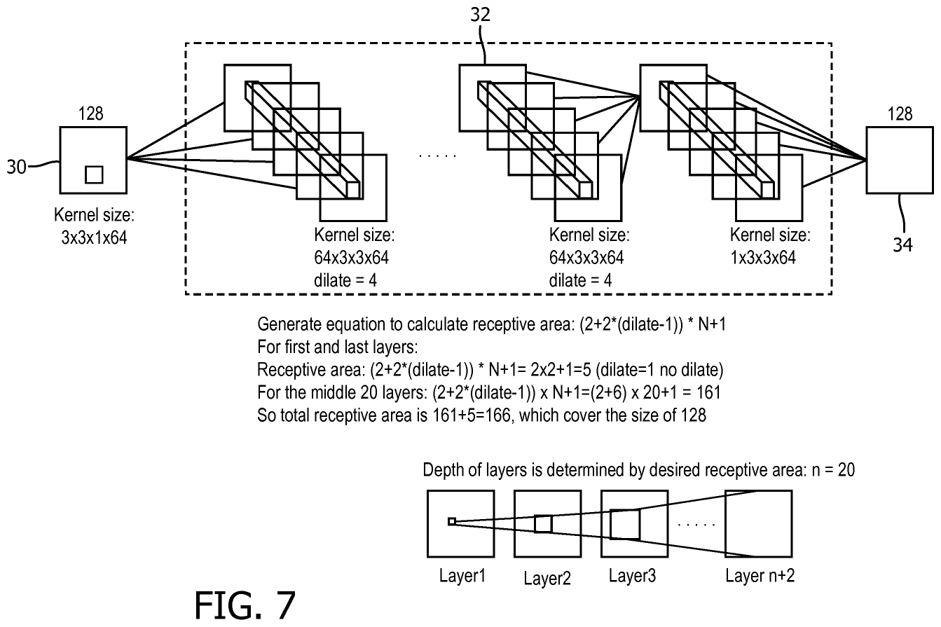

With reference to FIG. 7, as previously, noted the depth of the neural network 32 is preferably set so that the receptive field spans the area of the X-ray image 30 being processed. In other words, the neural network 32 preferably has a number of layers and a kernel size effective to provide global connectivity across the uncorrected X-ray image 30. FIG. 7 illustrates an approach for designing the neural network 32 to have the desired receptive field to span an image area of 128×128 pixels. This is merely an illustrative example, and other neural network configurations can be employed, e.g. comparable receptive areas can be obtained using fewer layers offset by a larger kernel size and/or dilate factor. Having the receptive field of the neural network 32 encompass the area of the X-ray image is advantageous because metal artifacts often comprises streaks or other artifact features the extend across much of the X-ray image area, or in some cases even extend across the entire image. By constructing the trained neural network 32 to have a receptive area that spans (i.e. encompasses, is co-extensive with) the area of the X-ray image, the neural network 32 can effectively generate the residual image 34 capturing these large-area metal artifact features.

The invention has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory storage medium storing instructions executable by at least one processor to perform an image reconstruction method, the method comprising:
reconstructing X-ray projection data to generate an uncorrected X-ray image;
applying a neural network to the uncorrected X-ray image to generate a metal artifact image; and
generating a corrected X-ray image by subtracting the metal artifact image from the uncorrected X-ray image;
wherein the neural network is trained to extract image content comprising a metal artifact.

2. The non-transitory storage medium of claim 1, further comprising training the neural network to transform polychromatic training X-ray images pⱼ where j indexes the training X-ray images to match respective metal artifact images aⱼ where pⱼ=mⱼ+aⱼ and component mⱼ is a metal artifact-free X-ray image.

3. The non-transitory storage medium of claim 1, wherein the neural network has a number of layers and a kernel size effective to provide global connectivity across the uncorrected X-ray image.

4. (canceled)

5. (canceled)

6. The non-transitory storage medium of claim 1, wherein the image reconstruction method further includes classifying the metal artifact image as to a metal type.

7. The non-transitory storage medium of claim 1, wherein the image reconstruction method further includes identifying a metal object depicted by the metal artifact image based on shape.

8. (canceled)

9. (canceled)

10. The non-transitory storage medium of claim 1, wherein the uncorrected X-ray image is a three-dimensional uncorrected X-ray image and the neural network is applied to the three-dimensional uncorrected X-ray image to generate the metal artifact image as a three-dimensional metal artifact image.

11. An imaging device, comprising:
an X-ray imaging device configured to acquire an uncorrected X-ray image; and
an image reconstruction device comprising at least one processor and a non-transitory storage medium storing instructions and executable by the at least one processor to perform an image correction method including:
applying a neural network to the uncorrected X-ray image to generate a metal artifact image wherein the neural network is trained to extract residual image content comprising a metal artifact; and
generating a corrected X-ray image by subtracting the metal artifact image from the uncorrected X-ray image.

12. The imaging device of claim 11, further comprising training the neural network (32) to transform polyenergetic training X-ray images pⱼ, where j indexes the training X-ray images, to match respective metal artifact images aⱼ where pⱼ=mⱼ+aⱼ and component mⱼ is a metal artifact-free X-ray image.

13. (canceled)

14. The imaging device of claim 11, further comprising:
a display device, wherein the image reconstruction method further includes displaying the corrected X-ray image on the display device.

15. The imaging device of claim 14, wherein the image reconstruction method further includes displaying the metal artifact image or an image derived from the metal artifact image on the display device.

16. The imaging device of claim 11, wherein the image reconstruction method further includes processing the metal artifact image to determine information about a metal object depicted by the metal artifact image.

17. The imaging device of claim 11, wherein the X-ray imaging device comprises at least one of a computed tomography imaging device, a C-arm imaging device, and a digital radiography device.

18. The imaging device of claim 11, wherein
the X-ray imaging device comprises a positron emission tomography/computed tomography imaging device having a CT gantry configured to acquire the uncorrected X-ray image and a PET gantry; and
the non-transitory storage medium further stores instructions executable by the at least one processor to generate an attenuation map from the corrected X-ray image for use in attenuation correction in PET imaging performed by the PET gantry.

19. A computer-implemented imaging method, comprising:
acquiring an uncorrected X-ray image using an X-ray imaging device;
applying a trained neural network to the uncorrected X-ray image to generate a metal artifact image; and
generating a corrected X-ray image by subtracting the metal artifact image from the uncorrected X-ray image.

20. (canceled)

21. (canceled)

22. The imaging method of claim 19, wherein the uncorrected X-ray image is a three-dimensional uncorrected X-ray image, and the trained neural network is applied to the three-dimensional uncorrected X-ray image to generate the metal artifact image as a three-dimensional metal artifact image, and the corrected X-ray image is generated by subtracting the three-dimensional metal artifact image from the three-dimensional uncorrected X-ray image.

23. The imaging method of claim 19, further comprising training the neural network to transform polyenergetic training X-ray images pⱼ to match respective metal artifact images aⱼ where j indexes the training X-ray images and pⱼ=mⱼ+aⱼ where image component mⱼ is a a metal artifact-free X-ray image.

24. The non-transitory storage medium according to claim 1, wherein the metal artifact image is processed to segment a metal artifact in the metal artifact image, a metal object giving rise to the metal artifact captured in the metal artifact image, wherein segmenting the metal artifact in the metal artifact image comprises utilizing a priori information relating to a shape of the metal object, and wherein segmenting the metal artifact in the metal artifact image comprises utilizing information relating to the shape of the metal object determined by locating or segmenting the metal artifact in the corrected X-ray image.

25. The imaging device according to claim 11, wherein the metal artifact image is processed to segment a metal artifact in the metal artifact image, a metal object giving rise to the metal artifact captured in the metal artifact image, wherein segmenting the metal artifact in the metal artifact image comprises utilizing a priori information relating to a shape of the metal object, and wherein segmenting the metal artifact in the metal artifact image comprises utilizing information relating to the shape of the metal object determined by locating or segmenting the metal artifact in the corrected X-ray image.

26. The computer-implemented imaging method according to claim 19, wherein the metal artifact image is processed to segment a metal artifact in the metal artifact image, a metal object giving rise to the metal artifact captured in the metal artifact image, wherein segmenting the metal artifact in the metal artifact image comprises utilizing a priori information relating to a shape of the metal object, and wherein segmenting the metal artifact in the metal artifact image comprises utilizing information relating to the shape of the metal object determined by locating or segmenting the metal artifact in the corrected X-ray image.
